(19) United States
(12) Patent Application Publication
(10) Pub. No.: US 2020/0265382 A1
(43) Pub. Date: Aug. 20, 2020

(54) DELIVERY SYSTEM, DELIVERY METHOD AND STORAGE MEDIUM

(71) Applicant: TOYOTA JIDOSHA KABUSHIKI KAISHA, Aichi-ken (JP)

(72) Inventors: Ayano TSURUTA, Toyota-shi (JP); Yasuhiro HARA, Nagoya-shi (JP); Junya WATANABE, Nagakute-shi (JP)

(21) Appl. No.: 16/785,657

(22) Filed: Feb. 10, 2020

(30) Foreign Application Priority Data
Feb. 15, 2019 (JP) 2019-025896

(51) Int. Cl. G06Q 10/08

(52) U.S. Cl. CPC G06Q 10/08355; G06Q 10/0838

(57) ABSTRACT

A delivery system includes: a judging section that, after a package is primarily moved to a vicinity of a delivery destination by a vehicle in which the package is accommodated, and the package is to be secondarily moved from the vehicle to the delivery destination by a moving body, judges whether or not there is a moving body that is available for secondary movement of the package among a first moving body that is loaded in the vehicle and a second moving body that is stationed at the delivery destination or a vicinity thereof; and a control section that, in a case in which it is judged by the judging section that there is a moving body that is available for the secondary movement of the package, causes the moving body that is available for the secondary movement of the package to carry out the secondary movement.

### CROSS-REFERENCE TO RELATED APPLICATION

This application is based on and claims priority under 35 USC 119 from Japanese Patent Application No. 2019-025896 filed on Feb. 15, 2019, the disclosure of which is incorporated by reference herein.

### BACKGROUND

### Technical Field

The present disclosure relates to a delivery system, a delivery method and a storage medium storing a delivery processing program.

### Related Art

Japanese Patent Application Laid-Open (JP-A) No. 2016-153337 discloses a delivery system in which a drone that is a moving object is, together with cargo to be delivered, loaded in a vehicle (a delivery vehicle) and is delivered. In this system, the delivery vehicle has, in the ceiling thereof, a takeoff/landing space and a cargo shipping opening, and has means for supplying cargo to this cargo shipping opening. The drone that receives the cargo flies to the delivery residence and delivers the cargo. Further, when deliveries by the drone in a given area are completed, the delivery vehicle moves together with the drone to another area, and carries out further deliveries.

In the technique disclosed in JP-A No. 2016-153337, the delivery of a package from the vehicle to the delivery destination is carried out by the drone that is loaded in the vehicle. However, with current drones, the availability rate is not necessarily high. For example, if the capacity of the battery is made larger in order to lengthen the time over which the drone can fly continuously, the time for charging the battery (i.e., the time that the drone is not available) becomes longer. Therefore, with the technique of this JP-A No. 2016-153337, there is the possibility that the efficiency of delivery will be insufficient due to the low availability rate of the drone becoming a bottleneck and periods arising in which packages cannot be delivered from the vehicle to delivery destinations.

In order to compensate for the availability rate per drone being low, it has been thought to load plural drones in the vehicle. However, in this case, the delivery efficiency is lowered due to there being a smaller amount of packages that is able to be accommodated in the vehicle.

### SUMMARY

The present disclosure has been made in consideration of the above-described circumstances, and provides a delivery system, a delivery method and a storage medium storing a delivery processing program, which may improve the efficiency of delivery in cases of delivering packages by using a vehicle, which accommodates the packages, and a moving body.

A first aspect of the present disclosure is a delivery system, and includes: a judging section that, after a package is primarily moved to a vicinity of a delivery destination by a vehicle in which the package is accommodated, and the package is to be secondarily moved from the vehicle to the delivery destination by a moving body, judges whether or not there is a moving body that is available for secondary movement of the package among a first moving body that is loaded in the vehicle and a second moving body that is stationed at the delivery destination or a vicinity thereof and a control section that, in a case in which it is judged by the judging section that there is a moving body that is available for the secondary movement of the package, causes the moving body that is available for the secondary movement of the package to carry out the secondary movement of the package.

In the first aspect, it is judged whether or not there is a moving body, which is available for the secondary movement of the package, among the first moving body that is loaded in the vehicle and the second moving body that is stationed at the delivery destination or a vicinity thereof. Due thereto, as compared with a case in which one moving body is judged that whether or not it is available in the secondary movement of the package, by increasing the number of moving bodies that are objects of judgment, the probability that it is judged that there is a moving body that is available for the secondary movement of the package P increases. Further, in a case in which it is judged that there is a moving body that is available for the secondary movement of the package, the secondary movement of the package is made to be carried out by that moving body that is available for the secondary movement of the package. Therefore, the efficiency of delivery in a case in which a package is delivered by using a moving body and a vehicle that accommodates the package may be improved.

In the first aspect, the judging section may judge whether or not, among the first moving body and the second moving body, there is a moving body that is available for the secondary movement of the package during a desired delivery time frame that is set for the package, and in a case in which it is judged by the judging section that there is a moving body that is available for the secondary movement of the package during the desired delivery time frame, the control section may cause the moving body that is available for the secondary movement of the package to carry out the secondary movement of the package during the desired delivery time frame.

In a case in which a desired delivery time frame is set for a package, the possibility that there is a moving body that is available for the secondary movement of the package is low, as compared with a case in which a desired delivery time frame is not set for the package (i.e., a case in which the secondary movement of the package may be carried out in an arbitrary time frame). However, in the above-described structure, it is judged whether or not there is, among the first moving body and the second moving body, a moving body that is available for the secondary movement of the package during the desired delivery time frame that has been set for the package. Therefore, the probability that it is judged that there is a moving body that is available for the secondary movement of the package during the desired delivery time frame, increases. Due thereto, the efficiency of delivery may be improved also in a situation in which a desired delivery time frame is set for a package.

In the first aspect, the control section may notify the delivery destination in a case in which it is judged by the judging section that there is no moving body that is available for the secondary movement of the package.

In a case in which there is no moving body that is available for the secondary movement of the package, it is difficult to deliver the package to the delivery destination in the initially supposed time frame and by the initially supposed delivery method. In the above-described structure, in such a case, the delivery destination may be made to recognize that it is difficult to deliver the package in the initially supposed time frame and by the initially supposed delivery method.

In the first aspect, in a case in which it is judged by the judging section that there is no moving body that is available for the secondary movement of the package, the control section may notify the delivery destination a first option that the package may be secondarily moved in a time frame in which any moving body is available, by a moving body that is available in the time frame, and, in a case in which the first option is selected by the delivery destination, the control section may cause the moving body that is available to carry out the secondary movement of the package in the time frame in which the moving body is available.

In the above-described structure, in a case in which it is difficult to deliver the package to the delivery destination in the initially supposed time frame, the delivery destination may select that the package be delivered in another time frame, and the delivery of the package may be completed in the another time frame.

In the first aspect, in a case in which it is judged by the judging section that there is no moving body that is available for the secondary movement of the package, the control section may notify the delivery destination a second option that a recipient of the package may go to the vehicle and pick-up the package, and, in a case in which the second option is selected by the delivery destination, the control section may cause the vehicle to traveled to the vicinity of the delivery destination and to stand-by until the recipient arrives.

In the above-described structure, in a case in which it is difficult to deliver the package to the delivery destination by the initially supposed delivery method, the delivery destination may select that the recipient of the package will go to the vehicle and pick-up the package, and the package may be handed-over to the recipient of the package without using a moving body.

In the first aspect, in a case in which it is judged by the judging section that there is no moving body that is available for the secondary movement of the package, the control section may notify the delivery destination a third option that delivery of the package may be cancelled, and, in a case in which the third option is selected by the delivery destination, the control section may cancel the secondary movement of the package.

In the above-described structure, in a case in which it is difficult to deliver the package to the delivery destination in the initially supposed time frame and by the initially supposed delivery method, the delivery destination may select that delivery of the package be cancelled.

A second aspect of the present disclosure is a delivery method that includes: after a package is primarily moved to a vicinity of a delivery destination by a vehicle in which the package is accommodated, and the package is to be secondarily moved from the vehicle to the delivery destination by a moving body, judging whether or not there is a moving body that is available for secondary movement of the package among a first moving body that is loaded in the vehicle and a second moving body that is stationed at the delivery destination or a vicinity thereof; and in a case in which it is judged that there is a moving body that is available for the secondary movement of the package, causing the moving body that is available for the secondary movement of the package to carry out the secondary movement of the package.

A third aspect of the present disclosure is a non-transitory storage medium storing a program that causes a computer to execute a delivery processing, the delivery processing including: after a package is primarily moved to a vicinity of a delivery destination by a vehicle in which the package is accommodated, and the package is to be secondarily moved from the vehicle to the delivery destination by a moving body, judging whether or not there is a moving body that is available for secondary movement of the package among a first moving body that is loaded in the vehicle and a second moving body that is stationed at the delivery destination or a vicinity thereof; and in a case in which it is judged that there is a moving body that is available for the secondary movement of the package, causing the moving body that is available for the secondary movement of the package to carry out the secondary movement of the package.

In the aspects of the present disclosure, the efficiency of delivery in a case in which a package is delivered by using a vehicle, in which the package is accommodated, and a moving body may be improved.

### BRIEF DESCRIPTION OF THE DRAWINGS

FIG. 1 is a schematic structural drawing of a delivery system relating to an embodiment.

FIG. 2 is an explanatory drawing that explains the flow by which cargo is delivered in a situation in which a drone is applied as a moving body.

FIG. 3 is a side sectional view illustrating the structure of a vehicle.

FIG. 4 is a block drawing illustrating hardware structures of equipment installed in a vehicle.

FIG. 5 is a side view illustrating the structure of the drone.

FIG. 6 is a block drawing illustrating hardware structures of the drone.

FIG. 7 is a table illustrating an example of operations schedule information.

FIG. 8 is a block drawing illustrating hardware structures of a delivery controlling server.

FIG. 9 is a table illustrating examples of delivery management information.

FIG. 10 is a flowchart illustrating delivery plan setting processing.

FIG. 11 is an image drawing illustrating an example of a message displayed on a user terminal.

FIG. 12 is a flowchart illustrating final delivery control processing.

FIG. 13 is an explanatory drawing that explains the flow by which cargo is delivered in a situation in which a traveling robot is applied as a moving body.

FIG. 14 is a side view illustrating the structure of the traveling robot.

### DETAILED DESCRIPTION

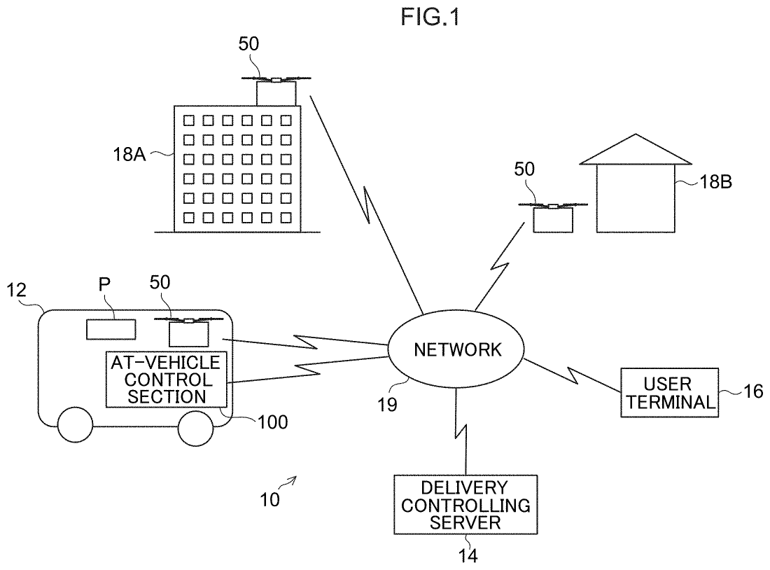

An example of an embodiment of the present disclosure is described in detail hereinafter with reference to the drawings. A delivery system 10 illustrated in FIG. 1 includes a vehicle 12 that is an autonomous vehicle, plural drones 50, a delivery controlling server 14, and a user terminal 16 such as a smartphone or the like. Note that the drone 50 is an example of the moving body.

A package P addressed to a specific user is accommodated in the vehicle 12, the drone 50 is loaded in the vehicle 12, and an at-vehicle control section 100 is provided at the vehicle 12. In addition to being loaded in the vehicle 12, the drones 50 are also stationed at specific buildings 18A, 18B. In FIG. 1, an apartment house (the building 18A) and a single-family detached home (the building 18B) are illustrated as examples of buildings at which the drones 50 are stationed. In the delivery system 10, the at-vehicle control section 100 of the vehicle 12, a drone controlling section 130 described later of the drone 50, the delivery controlling server 14, and the user terminal 16 are able to communicate with one another via a network 19.

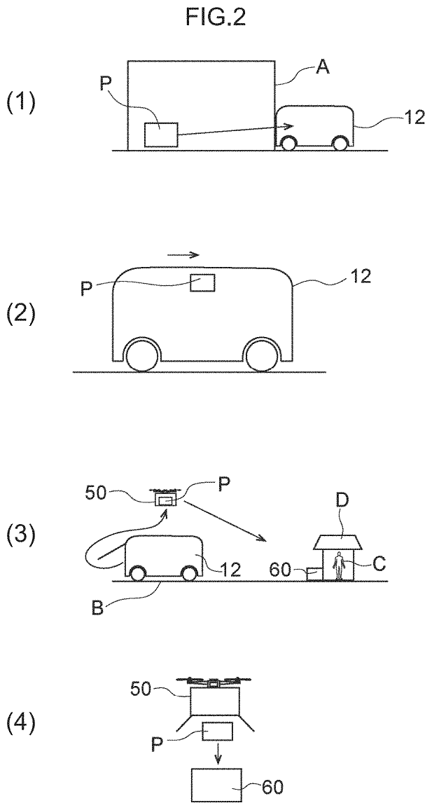

FIG. 2 illustrates the flow by which the package P is delivered by the delivery system 10. A product or the like that has been purchased by user C is accommodated in the vehicle 12 (refer to (1) in FIG. 2) by being loaded into the vehicle 12 as the package P from distribution center A, and the vehicle 12 travels toward delivery place D that is the residence of the user C (refer to (2) in FIG. 2). After the vehicle 12 reaches stop point B for delivery set in a vicinity of the delivery place D, the drone 50 collects the package P from the vehicle 12, and flies to the delivery place D (refer to (3) in FIG. 2). Then, the drone 50 drops the package P off into a delivery box 60 (refer to (4) in FIG. 2). Note that, instead of dropping the package P off into the delivery box 60, the drone 50 may place the package P flat on a predetermined place, or may directly hand the package P over to the user C.

Here, there are cases in which the drone 50 that collects the package P from the vehicle 12 is (A) a drone that is loaded in the vehicle 12, (B) a drone that is stationed at the building 18 that is the delivery place D and that flies in toward the vehicle 12 from the delivery place D, or (C) a drone that is stationed at a building 18 that is in the vicinity of the delivery place D and that flies in toward the vehicle 12 from the vicinity of the delivery place D.

(Vehicle)

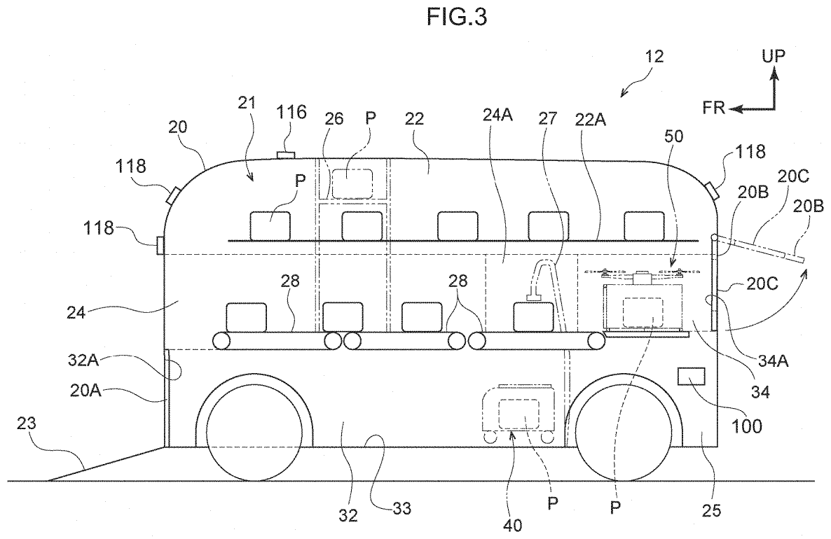

As illustrated in FIG. 3, the vehicle 12 has a vehicle body 20 that is substantially box-shaped and has a cabin 21 that is sectioned into three levels in the vehicle vertical direction. A cargo room 22 that accommodates the plural packages P is provided at the upper level of the cabin 21. A sorting room 24 in which the packages P are sorted is provided at the vehicle front side of the middle level of the cabin 21. A drone accommodating room 34, in which the plural drones 50 may be accommodated in the vehicle transverse direction, is provided at the vehicle rear side. The drones 50 that are loaded in the vehicle 12 are accommodated in the drone accommodating room 34.

A sorting work section 24A, in which the packages are sorted to the drones 50 or the traveling robots 40, is provided at the region that is adjacent to the drone accommodating room 34 at the vehicle rear side of the sorting room 24. Note that the traveling robot 40 also is an example of the moving body, and, in the same way as the drone 50, it may recover the package P and may travel to the delivery place D.

A vehicle accommodating room 32 that may accommodate the plural traveling robots 40 is provided at the vehicle front side of the lower level of the cabin 21, and a unit room 25 is provided at the vehicle rear side. The vehicle accommodating room 32 is provided at the vehicle lower side of the sorting room 24. The unit room 25 is provided at the vehicle lower side of the drone accommodating room 34. The driving devices of the vehicle 12 and the at-vehicle control section 100, which carries out control relating to automatic driving and the delivery of the packages P, are accommodated in the unit room 25. A Global Positioning System (GPS) device 116 is provided at the upper portion of the vehicle body 20, and plural environment sensors 118 are provided at the vehicle front side and the vehicle rear side.

A sliding door 20A, which is supported so as to be able to be opened and closed by being slid in the vehicle transverse direction, is provided at a door opening portion 32A that is at the vehicle front side of the vehicle accommodating room 32. A ramp 23 on which the traveling robots 40 may travel is provided at the vehicle front end portion of a floor 33 of the vehicle accommodating room 32 toward the road surface. The ramp 23 is able to be housed beneath the floor 33. In the present embodiment, when the sliding door 20A is opened, the traveling robot 40 may ride-up the ramp 23 and pass through the door opening portion 32A and may enter into the vehicle accommodating room 32. The sliding door 20A is opened and closed automatically by an unillustrated moving mechanism, and the ramp 23 movable by this moving mechanism in accordance with the operations of opening and closing the sliding door 20A.

Note that, instead of the sliding door 20A, a door that is supported at the vehicle lower side end portion of the door opening portion 32A such that the vehicle upper side thereof may rotate may be provided, and the door may be opened until the upper end side thereof contacts the road surface, and the inner side surface of this door may be used as a ramp.

Further, a hinged door 20B that is supported at the vehicle upper side end portion such that the vehicle lower side thereof is rotatable is provided at a door opening portion 34A that is at the vehicle rear side of the drone accommodating room 34. In the present embodiment, after the hinged door 20B is opened, the drone 50 may move through the door opening portion 34A between the drone accommodating room 34 and the vehicle exterior. The hinged door 20B is opened and closed automatically by an unillustrated opening/closing mechanism. Note that, instead of the hinged door 20B, a sliding door that is supported so as to be able to open and close by sliding with respect to the door opening portion 34A may be provided. Further, a window 20C is formed in the vehicle transverse direction and vehicle vertical direction central portion of the hinged door 20B.

A path (not illustrated), which extends in the vehicle longitudinal direction and the vehicle vertical direction, is provided at the vehicle transverse direction center of the cargo room 22, and racks 22A on which the packages P are placed are provided at the vehicle transverse direction both sides of the path. Further, a stacker crane 26, which is for moving the packages P of the cargo room 22 up and down and forward and rearward and is for moving the packages P to the sorting room 24, is provided on the path. Conveyers 28 for moving the packages P forward and rearward are provided at the floor portion from the sorting room 24, which includes the sorting work section 24A, to the drone accommodating room 34. Moreover, a robot arm 27 is provided from the sorting work section 24A to the vehicle accommodating room 32.

In the present embodiment, in a case in which a specific package P is handed-over to the traveling robot 40 or the drone 50, first, in the cargo room 22, the package P is placed by the stacker crane 26 from the rack 22A onto the conveyor 28 of the sorting room 24. In the sorting room 24, one of the packages P among the plural packages P is moved by the conveyors 28 to the sorting work section 24A. Then, at the sorting work section 24A, the package P is moved to the drone accommodating room 34 or to the vehicle accommodating room 32 in accordance with the moving body to which the package P is to be handed-over.

In a case in which the package P is moved to the drone accommodating room 34, the package P is accommodated by the conveyor 28 in an accommodating compartment 54 of the drone 50 that is described later. In a case in which the package P is moved to the vehicle accommodating room 32, the package P is accommodated by the robot arm 27 in an accommodating compartment 44 of the traveling robot 40 that is described later.

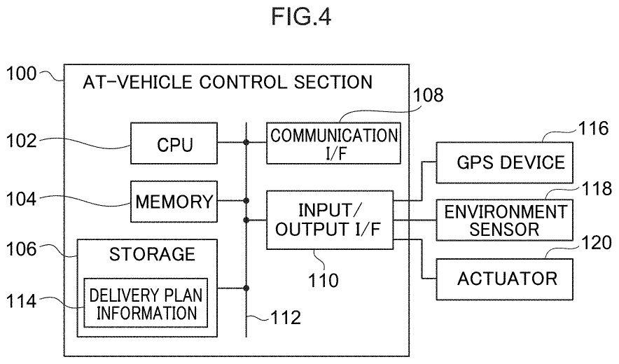

As illustrated in FIG. 4, in addition to the aforementioned at-vehicle control section 100, the vehicle 12 has the GPS device 116 that acquires the current position of the vehicle 12, the environment sensors 118 that recognize the environment at the periphery of the vehicle 12, and an actuator 120 that carries out accelerating and steering of the vehicle 12. Here, the environment sensors 118 include cameras that captures images of predetermined ranges, millimeter wave radars that transmit search waves over predetermined ranges, and Light Detection and Ranging/Laser Imaging Detection and Ranging (LIDAR) devices that scan predetermined ranges.

The at-vehicle control section 100 includes a Central Processing Unit (CPU) 102, a memory 104 such as a Read Only Memory (ROM) or a Random Access Memory (RAM) or the like, a non-volatile storage 106 such as a Hard Disk Drive (HDD) or a Solid State Drive (SSD) or the like, a communication Inter Face (I/F) 108 and an input/output I/F 110. The CPU 102, the memory 104, the storage 106, the communication I/F 108 and the input/output I/F 110 are communicably connected to one another via a bus 112. Further, delivery plan information 114 that is set by the delivery controlling server 14 is stored in the storage 106. The GPS device 116, the environment sensors 118 and the actuator 120 are connected to the input/output I/F 110.

The at-vehicle control section 100 acquires, from the GPS device 116, position information that expresses the current position of the vehicle 12. Further, the at-vehicle control section 100 acquires, from the environment sensors 118, traveling information of the vehicle 12 as traveling environment information, and recognizes the traveling environment at the periphery of the vehicle 12. Note that weather, brightness, the width of the road that is being traveled on, obstacles, and the like at the periphery of the vehicle 12 are included in the traveling environment information. Further, the traveling robot 40 that is traveling or the drone 50 that is flying also is included in the traveling environment information. Therefore, the at-vehicle control section 100 is able to recognize the traveling robot 40 or the drone 50.

The vehicle 12 is made to travel automatically due to the at-vehicle control section 100 causing the actuator 120 to operate in accordance with the delivery plan information 114 set by the delivery controlling server 14 and while taking the position information and the traveling environment information into consideration. Further, the at-vehicle control section 100 transmits position information of the vehicle 12 to the delivery controlling server 14.

Moreover, the at-vehicle control section 100 has a function of allowing the traveling robot 40 or the drone 50 to access the package P. “Allowing to access the package P” corresponds to both cases in which the traveling robot 40 or the drone 50 is accepted into the interior of the vehicle 12 where the package P is placed, and cases in which the package P is sent out to the exterior of the vehicle 12 where the traveling robot 40 or the drone 50 locates. The at-vehicle control section 100 opens the hinged door 20B in a case in which the existence of the drone 50 at the periphery of the vehicle 12 is recognized.

(Drone)

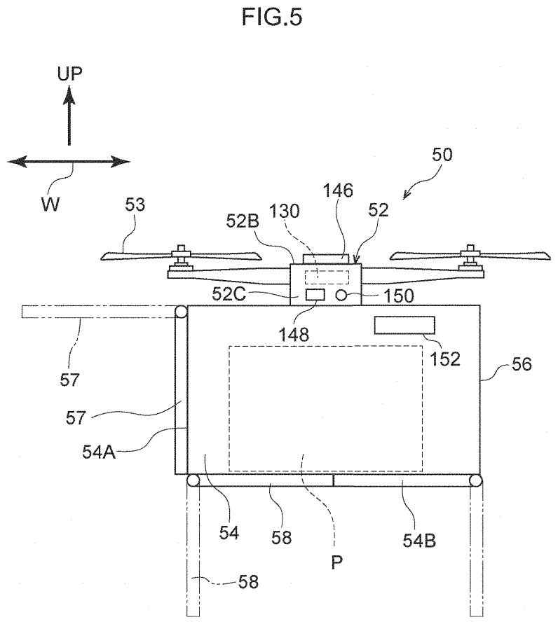

As illustrated in FIG. 5, the drone 50 includes a drone main body 52 that has plural propellers 53, and a transport box 56 that is fixed to the lower end of the drone main body 52.

The drone main body 52 has a substantial box shape, and a GPS device 146 is provided at an upper portion 52B of the drone main body 52. An environment sensor 148 that recognizes the environment at the periphery of the drone 50 is provided at at least a front side portion 52C of the body. Further, a camera 150 is provided at the front side portion 52C of the body. A drone controlling section 130 is provided inside the drone main body 52. Moreover, an LED display 152 that serves as a display device is provided at the front surface of the transport box 56.

The transport box 56 has a rectangular parallelepiped box shape, and the accommodating compartment 54 in which the package P is accommodated is provided at the interior thereof. One side wall portion 54A of the transport box 56 is formed as an opening/closing door 57 that swings toward the upper side of the body. A bottom portion 54B of the transport box 56 is formed as an opening/closing door 58 that is a double door that swings toward the lower side of the body.

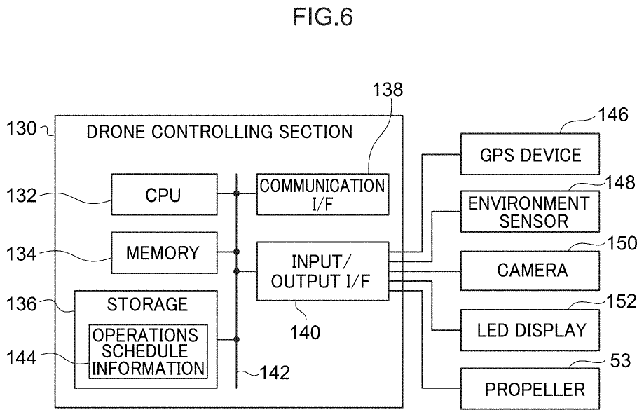

As illustrated in FIG. 6, in addition to the aforementioned drone controlling section 130, the drone 50 has the GPS device 146 that acquires the current position of the drone 50, and the environment sensor 148 that recognizes the environment of the periphery of the drone 50. Further, the drone 50 has the camera 150 that captures images of the periphery of the drone 50, and the LED display 152 that is able to display information about the package. The environment sensor 148 includes, for example, an ultrasonic sensor, a gyro sensor, an air pressure senor, a compass, and the like.

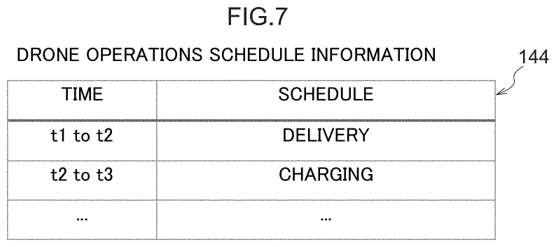

The drone controlling section 130 includes a CPU 132, a memory 134, a non-volatile storage 136, a communication I/F 138 and an input/output I/F 140. The CPU 132, the memory 134, the storage 136, the communication I/F 138 and the input/output I/F 140 are communicably connected via a bus 142 with one another. Operations schedule information 144 that expresses the operations schedule of the device itself (i.e., the drone 50 in which the drone controlling section 130 is installed) is stored in the storage 136. An example of the operations schedule information 144 is illustrated in FIG. 7. The GPS device 146, the environment sensor 148, the camera 150, the LED display 152 and the respective propellers 53 are connected to the input/output I/F 140.

The drone controlling section 130 acquires, from the GPS device 146, position information that expresses the current position of the drone 50. Further, the drone controlling section 130 acquires the flying environment of the drone 50 from the environment sensor 148 as flying environment information, and recognizes the flying environment at the periphery of the drone 50. Note that the flying environment information includes the weather, brightness, obstacles and the like at the periphery of the drone 50.

Further, the drone controlling section 130 drafts a flight plan (movement plan) for delivering the package P from the vehicle 12 to the delivery place D. At the drone 50 that is loaded in the vehicle 12, the aforementioned flight plan is a flight plan of receiving the package P at the vehicle 12, flying to the delivery destination D, dropping-off the package P, and thereafter, returning to the vehicle 12. Further, at the drone 50 that is stationed at the building 18 that is the delivery destination D, the aforementioned flight plan is a flight plan of flying from the delivery destination D (the building 18) to the vehicle 12, picking-up the package P at the vehicle 12, flying to the delivery destination D, and dropping-off the package P. At the drone 50 that is stationed at a building 18 that is not the delivery destination D, the aforementioned flight plan is a flight plan of flying from the building 18 to the vehicle 12, picking-up the package P at the vehicle 12, flying to the delivery destination D and dropping-off the package P, and thereafter, returning to the building 18.

The drone controlling section 130 has the function of flying the drone 50 by operating the respective propellers 53 in accordance with the drafted flight plan, while taking the flying environment into consideration. Further, the drone controlling section 130 has the functions of enabling collection of the package P by opening the opening/closing door 57, and enabling drop-off of the package P by opening the opening/closing door 58.

(Delivery Controlling Server)

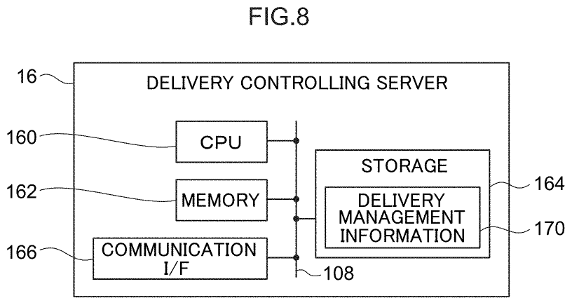

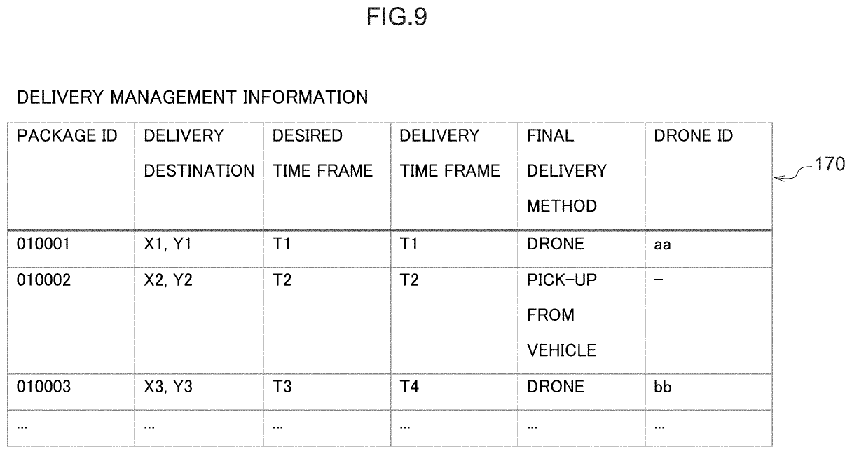

As illustrated in FIG. 8, the delivery controlling server 14 includes a CPU 160, a memory 162, a non-volatile storage 164, and a communication I/F 166. The CPU 160, the memory 162, the storage 164 and the communication I/F 166 are communicatively connected via a bus 168 with one another. The delivery controlling server 14 generates delivery management information 170 that manages information relating to the deliveries of the individual packages P accommodated in the vehicle 12, and stores the generated delivery management information 170 in the storage 164. An example of the delivery management information 170 is illustrated in FIG. 9. Programs, which cause the CPU 160 to execute delivery plan setting processing and final delivery control processing that are described later, also are stored in the storage 164. The CPU 160 reads-out the programs from the storage 164, and loads the programs in the memory 162 and executes the loaded programs. Due to the CPU 160 executing the programs, the delivery controlling server 14 functions as a judging section and a control section.

The delivery controlling server 14 acquires positional information of the vehicle 12, the traveling robot 40 and the drone 50 via the communication I/F 166. The delivery controlling server 14 drafts a delivery plan of the vehicle 12 from the distribution center A via one or more stop points B for delivery and reaching the distribution center A again, and stores the delivery plan in the storage 106 of the at-vehicle control section 100 as the delivery plan information 114.

The delivery controlling server 14 transmits, to the traveling robot 40 or the drone 50, position information of the vehicle 12 and the delivery destination, and instruction information that instructs collection of the package P from the vehicle 12. Specifically, the delivery controlling server 14 transmits, to the traveling robot 40 or the drone 50 that is to collect the package P, position information of the stop point B for delivery of the vehicle 12, package information of the package P, position information of the delivery destination, and instruction information.

### Operation of Embodiment

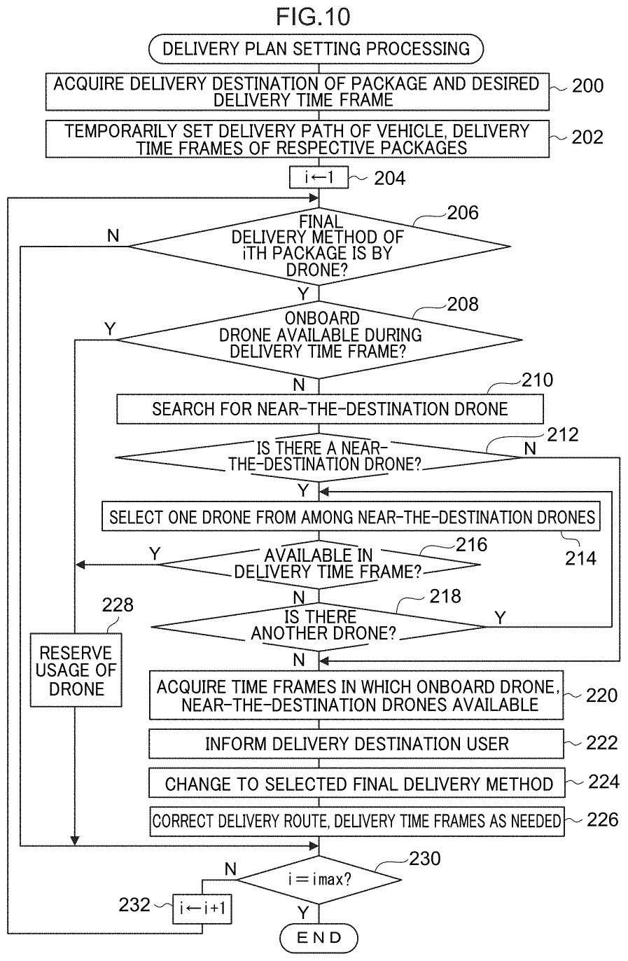

Next, the delivery plan setting processing executed by the CPU 160 of the delivery controlling server 14 is described as operation of the present embodiment, with reference to FIG. 10. Note that this delivery plan setting processing is executed before the packages P are loaded into the vehicle 12 at the distribution center A, or before the vehicle 12 that has laden with the packages P departs from the distribution center A.

In step 200 of the delivery plan setting processing, the delivery controlling server 14 acquires from, for example, a computer (not illustrated) that governs the distribution at the distribution center A, respective information that are a package ID, a delivery destination (delivery place D), a desired delivery time frame, and a final delivery method (to be described later), for each individual package P that is to be loaded (or has been loaded) into the vehicle 12.

In step 202, on the basis of the respective information acquired in step 200, the delivery controlling server 14 temporarily sets a delivery plan that includes a delivery route of the vehicle 12 and delivery time frames of the respective packages P. The information of the delivery plan that is temporarily set in step 202 includes position information of the stop points B for delivery that the vehicle 12 will pass through in order, approximate estimated stopping time frames of the vehicle 12 at the individual stop points B for delivery, and the package IDs of the packages P that are to be delivered to the delivery destinations by the drone 50 or the like at the individual stop points B for delivery.

In step 204, the delivery controlling server 14 sets variable i for identifying the individual package P to 1. In step 206, the delivery controlling server 14 judges whether or not the final delivery method of the ith package P is by drone or not.

As described above, in the present embodiment, after the package P is moved to a vicinity of the delivery destination by the vehicle 12 in which the package P has been loaded (this is called the first movement or the first delivery), the package P is moved from the vehicle 12 to the delivery destination by the drone 50 or the like (this is called the second movement or the final delivery). Here, the drone 50 is usually used in the final delivery, but there is also the possibility that the recipient of the package P will go to the vehicle 12 and pick-up the package.

In a case in which the final delivery method of the ith package P is “pick-up from vehicle”, the judgment in step 206 is negative, and the respective information that have been acquired in step 200 are registered in the delivery management information 170 as the information of the ith package P. Thereafter, the routine moves on to step 230. In a case in which the final delivery method of the ith package P is “by drone”, the judgment in step 206 is affirmative, and the routine moves on to step 208.

In step 208, the delivery controlling server 14 asks the drone controlling section 130 of the drone 50 that is loaded in the vehicle 12 (hereinafter called the “onboard drone 50”) whether or not the onboard drone 50 available during the desired delivery time frame of the ith package P. By collating the desired delivery time frame that has been notified with the operations schedule information 144 that is stored in the storage 136, the drone controlling section 130 of the onboard drone 50 replies whether or not it itself (the onboard drone 50) is available in the desired delivery time frame. On the basis of the contents of the response from the drone controlling section 130 of the onboard drone 50, the delivery controlling server 14 judges whether or not the onboard drone 50 is available during the desired delivery time frame of the ith package P. If the judgment in step 208 is affirmative, the routine moves on to step 228, usage of the onboard drone 50 is reserved, and the respective information acquired in step 200 and the drone ID of the onboard drone 50 are registered in the delivery management information 170 as the information of the ith package P. Thereafter, the routine moves on to step 230.

Due thereto, the drone controlling section 130 of the onboard drone 50 registers, in the operations schedule information 144, a schedule that it will carry out delivery in the time frame notified from the delivery controlling server 14 (for example, the first row of the operations schedule information 144 illustrate in FIG. 7). Further, in a case in which charging of the battery that is installed in the onboard drone 50 will be required accompanying this delivery, the drone controlling section 130 of the onboard drone 50 registers, in the operations schedule information 144, a schedule that charging of the battery is to be carried out after the delivery (for example, the second row of the operations schedule information 144 illustrated in FIG. 7).

Further, in a case in which the onboard drone 50 is not available in the desired delivery time frame of the ith package P due to a reason such as, for example, charging of the onboard drone 50 is planned or the like, the judgment in step 208 is negative, and the routine moves on to step 210. In step 210, the delivery controlling server 14 searches for the drone 50 (Hereinafter, called as the “near-the-destination drone 50”) that is stationed at the delivery destination of the ith package P or in a vicinity thereof (e.g., within a predetermined distance from the delivery destination).

The searching for the near-the-destination drone 50 may be realized by, for example, asking the drone controlling sections 130 of the individual drones 50, the stationed positions of the individual drones 50. However, searching is not limited to this, and may be carried out by referring to a map in which the stationed positions of the individual drones 50 are registered in advance.

In step 212, on the basis of the results of searching in step 210, the delivery controlling server 14 judges whether or not there is one or more near-the-destination drone 50. If there is no near-the-destination drone 50, the judgment in step 212 is negative, and the routine moves on to step 220. In a case in which one or more near-the-destination drone 50 exists, the judgment in step 212 is affirmative, and the routine moves on to step 214. In step 214, the delivery controlling server 14 selects one drone that is to be the object of judgment from among the near-the-destination drones 50 that have been extracted by the search. Note that the selection of the drone 50 that is the object of judgment may be carried out, for example, by selecting in the order of shortest flight distances needed to deliver the package P from among the near-the-destination drones 50.

Then, in step 216, the delivery controlling server 14 judges whether or not the drone 50 that is the object of judgment is available during the desired delivery time frame of the ith package P. If the judgment in step 216 is affirmative, the routine moves on to step 228, and usage of the drone that is the object of judgment (i.e., the near-the-destination drone 50) is reserved, and the respective information that have been acquired in step 200 and the drone ID of the drone 50 that is the object of judgment are registered in the delivery management information 170 as the information of the ith package P. Then, the routine moves on to step 230.

Further, in a case in which the drone 50 that is the object of judgment is no available during the desired delivery time frame of the ith package P, the judgment in step 216 is negative, and the routine moves on to step 218. In step 218, the delivery controlling server 14 judges whether or not there is, among the near-the-destination drones 50 extracted by searching, another drone 50 that has not been selected. If the judgment in step 218 is affirmative, the routine returns to step 214, and step 214 through step 218 are repeated until either the judgment of step 216 is affirmative or the judgment of step 218 is negative.

As described above, also in a case in which the onboard drone 50 is not available for delivery during the desired delivery time frame of the package P, by searching for the near-the-destination drones 50 and judging in order whether the near-the-destination drones 50 may be used for delivery in the desired delivery time frame of the package P, the probability of a drone that is usable to deliver the package P appearing (i.e., the probability of the judgment in step 216 being affirmative) is higher.

On the other hand, in a case in which there is no drone that is available during the desired delivery time frame of the ith package P even among the near-the-destination drones 50, the judgment in step 218 is negative, and the routine moves on to step 220. In step 220, by carrying out communication with the drone controlling section 130 of the onboard drone 50 and the drone controlling sections 130 of the near-the-destination drones 50, the delivery controlling server 14 acquires a time frame in which the onboard drone 50 or a near-the-destination drone 50 is available.

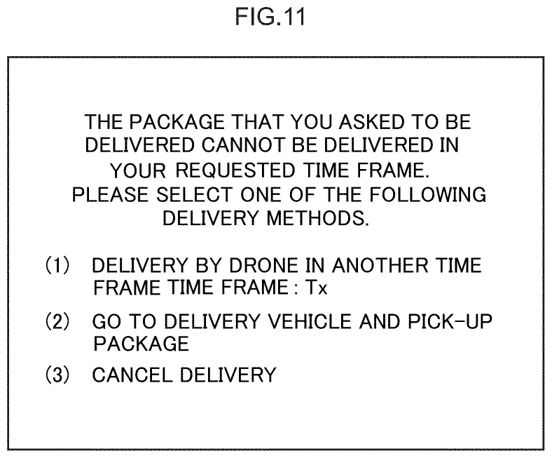

In step 222, the delivery controlling server 14 informs the user terminal 16 of the user who is to pick-up the ith package P that delivery is not possible during the desired delivery time frame, and notifies the user of choices of alternative methods. Due thereto, a message such as illustrated in FIG. 11 as an example is displayed on the user terminal 16. In the present embodiment, there are three options for an alternative method in a case in which delivery is not possible during the desired delivery time frame, which are, as illustrated in FIG. 11, (1) delivery by the drone 50 during another time frame (this another time frame that is displayed is the time frame acquired in step 220), (2) the user going to the vehicle 12 and picking-up the package P, and (3) cancelling of delivery.

After any of the options of alternative methods is selected by the user who is viewing the message displayed on the the user terminal 16, in subsequent step 224, the delivery controlling server 14 changes the final delivery method in the respective information acquired in step 200 to a final delivery method that corresponds to the selected choice. Further, if the selected option is “(1) delivery by the drone 50 during another time frame”, usage of the drone 50 that is available in the time frame acquired in step 220 is reserved.

Further, in step 226, accompanying the fact that it is not possible to deliver the ith package in the desired delivery time frame, the delivery controlling server 14 corrects the delivery plan, which includes the delivery route of the vehicle 12 and the delivery time frames of the respective packages P, as needed. In a case in which “(2) the user will go to the vehicle 12 and pick-up the package P” is selected as the option of the alternative method in a case in which delivery is not possible in the desired delivery time frame, this correction of the delivery plan also includes correcting the stop point B for delivery to a place that is nearer to the residence of the user. Further, the delivery controlling server 14 registers, in the delivery management information 170 and as the information for the ith package P, the information corrected in accordance with the correction of the delivery plan. As an example, in the third row of the delivery management information 170 illustrated in FIG. 9, the delivery time frame is different from the desired time frame, and this shows that the delivery plan has been corrected.

In step 230, the delivery controlling server 14 judges whether or not the variable i has reached the total number imax of the packages P that are loaded in (have been loaded in) the vehicle 12. If the judgment in step 230 is negative, the routine moves on to step 232. In step 232, the delivery controlling server 14 increments the variable i by 1. After the processing of step 232 is carried out, the routine returns to step 206, and step 206 through step 230 are repeated until the judgment of step 230 becomes affirmative. Then, after the judgment of step 230 is affirmative, the at-vehicle control section 100 of the vehicle 12 is notified of the delivery plan information 114 that expresses the delivery plan that has been established finally, and the delivery plan setting processing ends.

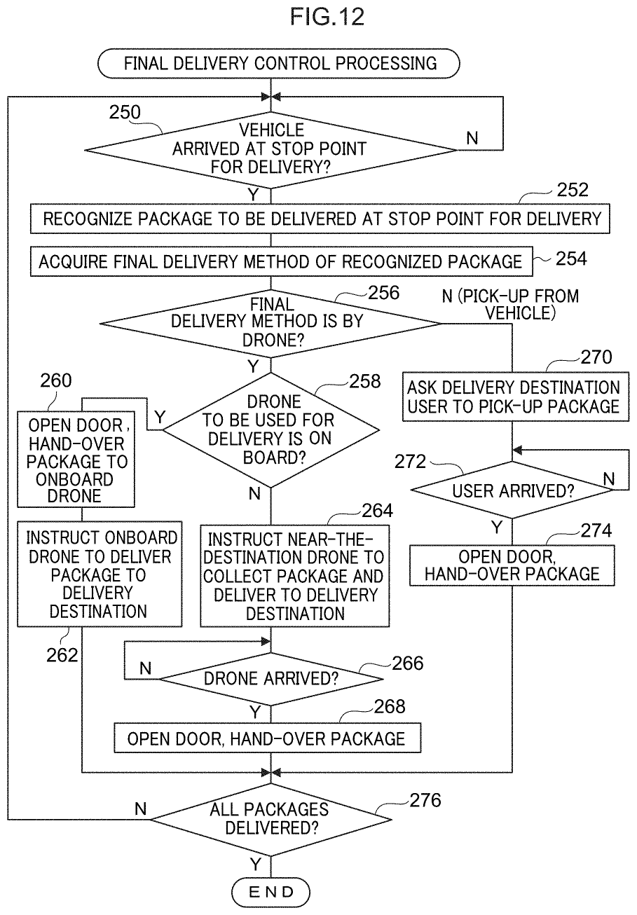

The final delivery control processing that is executed by the CPU 160 of the delivery controlling server 14 is described next with reference to FIG. 12. Note that this final delivery control processing is executed after the vehicle 12 in which the packages 12 have been loaded departs from the distribution center A.

In step 250 of the final delivery control processing, the delivery controlling server 14 judges whether or not the vehicle 12 has reached the stop point B for delivery, and step 250 is repeated until this judgment is affirmative. When the vehicle 12 reaches the stop point B for delivery, the judgment in step 250 is affirmative, and the routine moves on to step 252. In step 252, the delivery controlling server 14 refers to the delivery management information 170, and recognizes the package P that is to be delivered at the stop point B for delivery. In step 254, the delivery controlling server 14 acquires the final delivery method of the package P that has been recognized in step 252.

In step 256, the delivery controlling server 14 judges whether or not the final delivery method that has been acquired in step 254 is “by drone”. If the judgment in step 256 is affirmative, the routine moves on to step 258. In step 258, the delivery controlling server 14 judges whether or not the drone 50 that is to be used in delivery this time is the onboard drone 50. If the judgment in step 258 is affirmative, the routine moves on to step 260.

In step 260, the delivery controlling server 14 instructs the at-vehicle control section 100 to open the hinged door 20B and accommodate the package P in the accommodating compartment 54 of the onboard drone 50 by the conveyor 28. Due thereto, the package P is accommodated in the accommodating compartment 54 of the onboard drone 50. Further in subsequent step 262, the delivery controlling server 14 instructs the onboard drone 50 to deliver the package P to the delivery destination. Due thereto, the onboard drone 50 that accommodates the package P in the accommodating compartment 54 thereof flies toward the delivery destination D, and drops the package P off in the delivery box 60 and completes the delivery (refer to (4) of FIG. 2).

In a case in which the drone 50 that is to be used in the delivery this time is a near-the-destination drone 50, the judgment in step 258 is negative, and the routine moves on to step 264. In step 264, the delivery controlling server 14 instructs the near-the-destination drone 50 that is to be used in delivery this time to collect the package P and deliver the package P to the delivery destination. Due thereto, the near-the-destination drone 50 first flies from the delivery destination D or the building 18 that is in the vicinity of the delivery destination D toward the vehicle 12. In next step 266, the delivery controlling server 14 judges whether or not the arrival of the near-the-destination drone 50 at the vehicle 12 has been recognized by the at-vehicle control section 100, and the judgment of step 266 is repeated until becoming affirmative.

When it is sensed that the near-the-destination drone 50 has arrived at the vehicle 12 and that information about the package P is displayed by the LED display 152, the judgment in step 266 is affirmative, and the routine moves on to step 268. In step 268, the delivery controlling server 14 instructs the at-vehicle control section 100 to open the hinged door 20B. After the hinged door 20B is opened, the near-the-destination drone 50 that has arrived at the vehicle 12 may enter into the drone accommodating room 34 and park therein.

The delivery controlling server 14 instructs the at-vehicle control section 100 such that the package P is accommodated in the accommodating compartment 54 of the near-the-destination drone 50 by the conveyor 28. Due thereto, the package P is accommodated in the accommodating compartment 54 of the near-the-destination drone 50. Thereafter, the near-the-destination drone 50 in whose accommodating compartment 54 the package is accommodated flies toward the delivery destination D, and drops the package P off in the delivery box 60 and completes the delivery (refer to (4) of FIG. 2).

In a case in which the final delivery method acquired in step 254 is “pick-up from vehicle”, the judgment in step 256 is negative, and the routine moves on to step 270. In step 270, the delivery controlling server 14 transmits a message requesting pick-up of the package P to the user terminal 16 of the user who is to pick-up the package P. Due thereto, the user who is to pick-up the package P goes to the stop point B for delivery.

In next step 272, the delivery controlling server 14 judges whether or not the arrival of the user at the vehicle has been recognized by the at-vehicle control section 100. The judgment of step 272 is repeated until becoming affirmative. When the user arrives at the vehicle 12, and, for example, it is sensed that predetermined information (e.g., information about the package P or the like) is displayed on the user terminal 16 that is held-up to the vehicle 12, the judgment in step 272 is affirmative, and the routine moves on to step 274. In step 274, the delivery controlling server 14 instructs the at-vehicle control section 100 to open the hinged door 20B and send the package P out by the conveyors 28 toward the drone accommodating room 34. Due thereto, the user who has arrived at the vehicle 12 may take the package P out from the drone accommodating room 34, and the package P is handed-over to the user.

In step 276, the delivery controlling server 14 judges whether or not delivery of all of the packages P loaded in the vehicle 12 (except for those packages P for which delivery has been cancelled) has been completed. If the judgment in step 276 is negative, the routine returns to step 250, and step 250 through step 276 are repeated until the judgment of step 276 becomes affirmative. After the delivery of all of the packages P loaded in the vehicle 12 is completed, the judgment of step 276 is affirmative, and, due thereto, the final delivery control processing ends.

As described above, in the present embodiment, after the package P is primarily moved to a vicinity of the delivery destination by the vehicle 12 that accommodates the package P, when the package P is being secondarily moved by the drone 50 from the vehicle 12 to the delivery destination, it is judged whether or not, among the onboard drone 50 that is loaded in the vehicle 12 and the near-the-destination drone(s) 50 that is/are stationed at the delivery destination or in a vicinity thereof, there is a drone that is available for the secondary movement of the package P. Then, if it is judged that there is a drone 50 that is available for the secondary movement of the package P, the secondary movement of the package P is carried out by the drone 50 that is available for the secondary movement of the package P. Due thereto, as compared with a case in which one drone 50 is judged as to whether or not it is available for the secondary movement of the package P, by increasing the number of drones 50 that are objects of judgment, the probability that it will be judged that there is a drone 50 that is available for the secondary movement of the package P increases. Accordingly, the efficiency of delivery in a case in which the package P is delivered by using the vehicle 12 in which the package P is accommodated and the drone 50 may be improved.

In the present embodiment, it is judged whether or not there is a drone 50, which is available for the secondary movement of the package P during the desired delivery time frame that is set for the package P, exists among the onboard drone 50 and the near-the-destination drones 50, and, in a case in which it is judged that there is a drone 50 that is available for the secondary movement of the package P during the desired delivery time frame does, the secondary movement of the package P during the desired delivery time frame is carried out by that drone 50 that is available for the secondary movement of the package P. Due thereto, the probability that it will be judged that there is a drone 50, which is available for the secondary movement of the package P during the desired delivery time frame, increases, and the efficiency of delivery in a situation in which a desired delivery time is set for the package P may be improved.

In the present embodiment, in a case in which it is judged that there is no drone 50 that is available for the secondary movement of the package P, the delivery destination is notified of this fact. Therefore, in a case in which there is no drone 50 that is available for the secondary movement of the package P, the delivery destination may be made to recognize that it will be difficult to deliver the package in the initially supposed time frame and by the initially supposed delivery method.

In the present embodiment, in a case in which it is judged that there is no drone 50 that is available for the secondary movement of the package P, the delivery destination is informed of a first option that the package P will be secondarily moved in a time frame in which any of the drones 50 is available, by the drone 50 that is available during that time frame. In a case in which the first option is selected by the delivery destination, the secondary movement of the package P is carried out by the drone 50 in the time frame in which the drone 50 is available. Due thereto, in a case in which it is difficult to deliver the package P to the delivery destination in the initially supposed time frame, the delivery destination may select delivery of the package P in another time frame, and the delivery of the package P in the another time frame may be completed.

Further, in the present embodiment, in a case in which it is judged that there is no drone 50 that is available for the secondary movement of the package P, the delivery destination is informed of a second option that the recipient of the package P may go to the vehicle 12 and pick-up the package P. In a case in which the second option is selected by the delivery destination, the vehicle 12 that has traveled to a vicinity of the delivery destination is made to stand-by until the recipient arrives. Due thereto, in a case in which it is difficult to deliver the package P to the delivery destination by the initially supposed delivery method, the delivery destination may select that the recipient of the package P may go to the vehicle 12 and pick-up the package P, and the package P may be handed-over to the recipient of the package P without using the drone 50.

Further, in the present embodiment, in a case in which it is judged that there is no drone 50 that is available for the secondary movement of the package P, the delivery destination is informed of a third option of cancelling delivery of the package P. In a case in which the third option is selected by the delivery destination, the secondary movement of the package P is cancelled. Due thereto, in a case in which it is difficult to deliver the package P to the delivery destination in the initially supposed time frame and by the initially supposed delivery method, the delivery destination may select that delivery of the package P be cancelled.

Note that the above-described drone 50 collects the package P in the accommodating compartment 54 that is at the interior of the transport box 56 that is provided at the lower end of the drone main body 52, but the method of recovery is not limited to this. For example, a robot arm may be provided at the lower portion of the drone main body 52, and the package P may be collected by being grasped by this robot arm.

Further, the above describes a situation in which, first, it is judged whether or not the onboard drone 50 is available for delivering the package P, and, in a case in which the onboard drone 50 is not available for the delivery of the package P, it is judged whether or not the near-the-destination drones 50 is available for the delivery of the package P, and due thereto, the onboard drone 50 is given priority in usage over the near-the-destination drones 50. However, the present disclosure is not limited to this, and the near-the-destination drones 50 may be given priority in usage over the onboard drone 50. Further, the near-the-destination drones 50 are not limited to the drones 50 that are stationed at the buildings 18, and may be the drones 50 that are loaded in other vehicles 12 that exist in the vicinity.

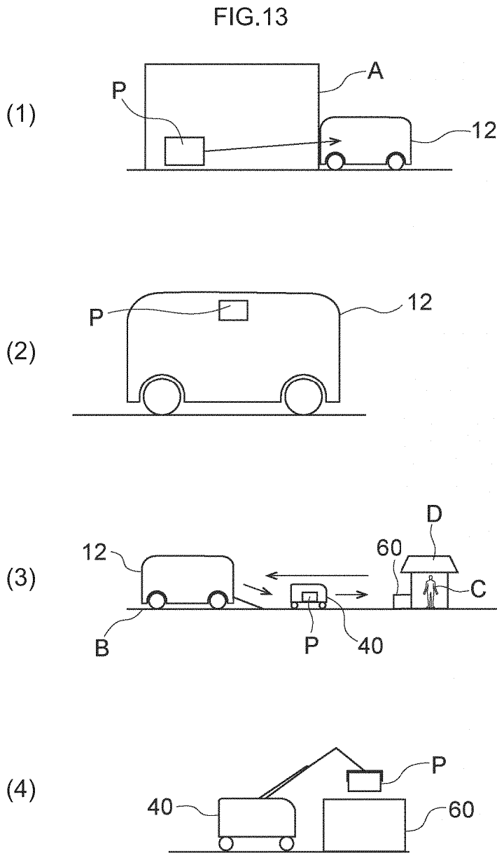

The above describes a situation in which the drone 50 is employed as the moving body, however, the disclosure is not limited there to and the traveling robot 40 may be applied as the moving body. In a case of using the traveling robot 40 as the moving body, the flow of delivery of the package P is illustrated in FIG. 13. A product or the like that has been purchased by the user C is loaded into the vehicle 12 from the distribution center A and as the package P (refer to (1) of FIG. 13), and the vehicle 12 travels toward the delivery place D that is the residence of the user C (refer to (2) in FIG. 13). After the vehicle 12 reaches the stop point B for delivery that is set in a vicinity of the delivery place D, the traveling robot 40 collects the package P from the vehicle 12, and travels to the delivery place D (refer to (3) in FIG. 13). Then, the traveling robot 40 places the package P in the delivery box 60 (refer to (4) in FIG. 13). Note that, instead of placing the package P in the delivery box 60, the traveling robot 40 may place the package P flat on a predetermined place, or may directly hand the package P over to the user C.

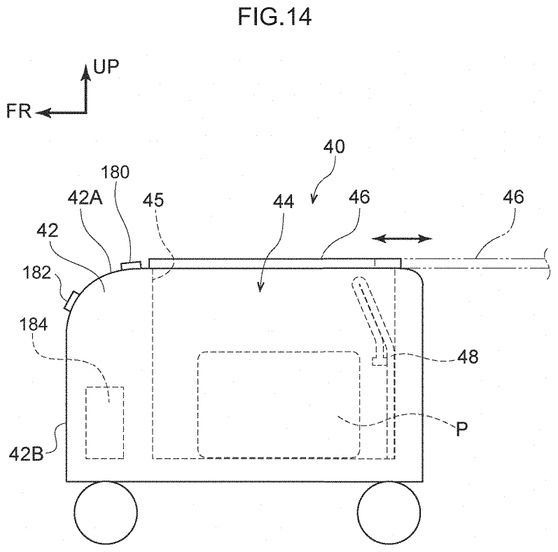

As illustrated in FIG. 14, the traveling robot 40 includes a vehicle body 42 that has a substantial box shape, the accommodating compartment 44 that is at the interior of the vehicle body 42 and in which the package P is accommodated, and a cover 46 that closes off an opening 45 at the upper portion of the accommodating compartment 44. The cover 46 is supported movable in the vehicle longitudinal direction, by rails (not illustrated) which are provided at the vehicle transverse direction both sides of the opening 45. The opening 45 is opened due to the cover 46 moving toward the vehicle rear side from the upper portion of the opening 45. Further, the traveling robot 40 includes a robot arm 48 for moving the package P from the accommodating compartment 44 to the exterior of the vehicle.

A GPS device 180 is provided at an upper portion 42A of the vehicle body 42, and an environment sensor 182 is provided at least at a vehicle front side portion 42B of the vehicle body 42. A control section 184 is provided at the interior of the vehicle body 42. Here, similarly to the environment sensors 118 that the vehicle 12 has, the environment sensor 182 includes a camera, a millimeter wave radar, and a LIDAR device.

Although the above description gives the example of the drone 50 as a moving body that flies, the present disclosure is not limited to this, and a radio-controlled plane, a radio-controlled helicopter, or the like may be used as the moving body. Further, although the above description gives the example of the traveling robot 40 as the moving body that travels, the present disclosure is not limited to this, and a radio-controlled car, a traveling robot, or the like may be made to be the land-based traveling body.

The programs of the present disclosure may be stored on an external server, and may be loaded to a memory via a network. Further, the programs may be stored on a non-transitory storage medium such as a Digital Versatile Disk (DVD) or the like, and may be loaded to a memory via a storage medium reading device.

What is claimed is:

1. A delivery system comprising:
a memory; and
a processor coupled to the memory and that is configured to:
judge, after a package is primarily moved to a vicinity of a delivery destination by a vehicle in which the package is accommodated, and the package is to be secondarily moved from the vehicle to the delivery destination by a moving body, whether or not there is a moving body that is available for secondary movement of the package among a first moving body that is loaded in the vehicle and a second moving body that is stationed at the delivery destination or a vicinity thereof; and
in a case in which it is judged that there is a moving body that is available for the secondary movement of the package, cause the moving body that is available for the secondary movement of the package to carry out the secondary movement of the package.

2. The delivery system of claim 1, wherein the processor is further configured to:
judge whether or not, among the first moving body and the second moving body, there is a moving body that is available for the secondary movement of the package during a desired delivery time frame that is set for the package, and
in a case in which it is judged that there is a moving body that is available for the secondary movement of the package during the desired delivery time frame, cause the moving body that is available for the secondary movement of the package to carry out the secondary movement of the package during the desired delivery time frame.

3. The delivery system of claim 1, wherein the processor is further configured to notify the delivery destination in a case in which it is judged that there is no moving body that is available for the secondary movement of the package.

4. The delivery system of claim 3, wherein the processor is further configured to, in a case in which it is judged that there is no moving body that is available for the secondary movement of the package, notify the delivery destination a first option that the package may be secondarily moved in a time frame in which any moving body is available, by a moving body that is available in the time frame, and, in a case in which the first option is selected by the delivery destination, cause the moving body that is available to carry out the secondary movement of the package in the time frame in which the moving body is available.

5. The delivery system of claim 3, wherein the processor is further configured to, in a case in which it is judged that there is no moving body that is available for the secondary movement of the package, notify the delivery destination a second option that a recipient of the package may go to the vehicle and pick-up the package, and, in a case in which the second option is selected by the delivery destination, cause the vehicle to traveled to the vicinity of the delivery destination and to stand-by until the recipient arrives.

6. The delivery system of claim 3, wherein the processor is further configured to, in a case in which it is judged that there is no moving body that is available for the secondary movement of the package, notify the delivery destination a third option that delivery of the package may be cancelled, and, in a case in which the third option is selected by the delivery destination, cancel the secondary movement of the package.

7. A delivery method comprising:
after a package is primarily moved to a vicinity of a delivery destination by a vehicle in which the package is accommodated, and the package is to be secondarily moved from the vehicle to the delivery destination by a moving body, judging whether or not there is a moving body that is available for secondary movement of the package among a first moving body that is loaded in the vehicle and a second moving body that is stationed at the delivery destination or a vicinity thereof; and
in a case in which it is judged that there is a moving body that is available for the secondary movement of the package, causing the moving body that is available for the secondary movement of the package to carry out the secondary movement of the package.

8. A non-transitory storage medium storing a program that causes a computer to execute a delivery processing, the delivery processing comprising:
after a package is primarily moved to a vicinity of a delivery destination by a vehicle in which the package is accommodated, and the package is to be secondarily moved from the vehicle to the delivery destination by a moving body, judging whether or not there is a moving body that is available for secondary movement of the package among a first moving body that is loaded in the vehicle and a second moving body that is stationed at the delivery destination or a vicinity thereof; and
in a case in which it is judged that there is a moving body that is available for the secondary movement of the package, causing the moving body that is available for the secondary movement of the package to carry out the secondary movement of the package.
